(19) United States
(12) Patent Application Publication
(10) Pub. No.: US 2016/0327241 A1
(43) Pub. Date: Nov. 10, 2016

(54) LUMINAIRE ASSEMBLY

(71) Applicant: 3M INNOVATIVE PROPERTIES COMPANY, St. Paul, MN (US)

(72) Inventors: John A. Wheatley, Lake Elmo, MN (US); Jon A. Kirschhoffer, Stillwater, MN (US); Scott E. Simons, Forest Lake, MN (US); Karl Geisler, Saint Paul, MN (US); Glendon D. Kappel, Eagan, MN (US); Brett A. Howell, Ramsey, MN (US); Andrew H. Tilstra, Shoreview, MN (US); Jo A. Etter, Roseville, MN (US)

(21) Appl. No.: 15/146,513

(22) Filed: May 4, 2016

Related U.S. Application Data
(60) Provisional application No. 62/156,671, filed on May 4, 2015.

(51) Int. Cl. F21V 7/00; F21V 9/00; F21V 15/01; F21V 8/00; F21V 3/04

(52) U.S. Cl. CPC F21V 7/0091; G02B 6/0096; F21V 3/049; F21V 15/01; F21V 9/00; F21Y 2101/02

(57) ABSTRACT

Luminaire assemblies are described. In particular, luminaire assemblies that include a dimensionally stable housing and a hollow waveguiding core having a length and capable of transporting light along the length removably nested within the housing are described. Luminaire systems including two or more luminaire assemblies are also described.

### BACKGROUND

Luminaires are used for task-specific and general illumination purposes. Luminaires may be used in indoor areas where natural light is insufficient or for, as an example, in outdoor areas during the evening or night. Luminaires can provide general purpose illumination, decorative illumination, or a combination of general purpose and decorative illumination.

### SUMMARY

In one aspect, the present description relates to a luminaire assembly. In particular, the luminaire assembly includes a dimensionally stable housing and a hollow waveguiding core having a length and capable of transporting light along the length removably nested within the housing.

In another aspect, the present description relates to a luminaire system. The luminaire system includes two or more of the luminaire assemblies, disposed such that light transported within the hollow waveguiding core of at least one of the luminaire assemblies enters the hollow waveguiding core of another of the luminaire assemblies.

### BRIEF DESCRIPTION OF THE DRAWINGS

FIG. 1 is a separated top perspective view of luminaire assembly components.

FIG. 2 is a top perspective view of a luminaire assembly.

FIG. 3 is a partial top perspective view of several connected luminaire assemblies.

FIG. 4 is a top perspective view of a luminaire assembly.

### DETAILED DESCRIPTION

Luminaires are typically of two general classes: fixed luminaires such as those permanently built into indoor spaces and portable luminaires such as desk lamps. Fixed luminaires may be designed with the particular illumination needs of the space or area in mind and therefore tend to be carefully selected as appropriate for the application. Portable luminaires may be designed with less of a specific space in mind; instead being designed with flexibility to utilize these luminaires in a variety of different spaces.

In the present description, luminaire assemblies that may be capable of incorporating characteristics generally associated with both portable luminaires (e.g., being lightweight, easily movable, application flexibility of design) and fixed luminaires (e.g., increased ability to provide appropriate illumination to the particular environment) are described. Such assemblies may be appropriate where luminaires are used to provide informational, decorative, and/or general purpose lighting in a temporary indoor or outdoor space: for example, at a booth at a trade show or under a tent at a weekend-long festival. Because of the need for these luminaires to be easily assembled, disassembled, and transported, luminaires described herein may be particularly advantageous, while still allowing for impressive and interesting lighting meeting the particular needs of the space.

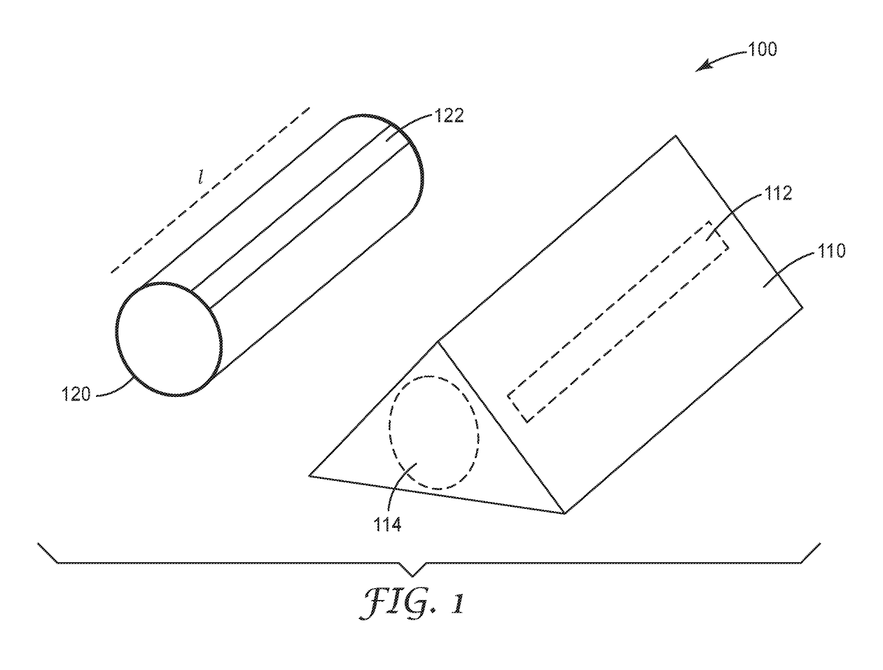

FIG. 1 is a separated top perspective view of luminaire assembly components. Luminaire assembly 100 includes housing 110 with light aperture 112 and insertion aperture 114 and waveguiding core 120 including transmitting portion 122.

Housing 110 may be any suitable shape and any suitable size. In some embodiments, housing 110 has a shape with flat facets such that housing 110 may be stably placed on the floor or ground without rolling or tipping. In some embodiments, housing 110 may be designed to stand on an end. In some embodiments, housing 110 may be designed to rest on its side. Housing 110 may be other shapes, including cylinders and spheres, and may be designed to be hung from a wire or string. In some embodiments, a round housing may be provided with feet or a flat base to allow for luminaire assembly 100 to be placed on the ground. In some embodiments, pins or spikes may be included for housing 110 such that it may be anchored in the ground. Other attachment mechanism such as suction cups or pressure sensitive adhesives may be included.

The size of housing 110 may depend on the particular application and also the material used for housing 110. For example, in some embodiments, housing 110 may include or be made from paperboard, cardboard, or other wood pulp materials. As these tend to be lighter weight than, for example, many plastics, metals, or metal alloys, this material selection may allow for a larger size for housing 110 while still having a manageable overall weight. Similarly, for heavier materials, housing 110 may need to be a smaller size in order to provide comparable portability. In some embodiments, the substrate may be non-conductive. In some embodiments, the substrate may be or include a composite material, such as fiber-reinforced plastic (FRP), including fiberglass. In some embodiments, the substrate may be a metal or a foam core material, such as two aluminum sheets with a polypropylene or polyethylene core.

In some embodiments, housing 110 may be a rigid housing. In some embodiments, housing 110 may be dimensionally stable. In some embodiments, housing 110 is foldable or collapsible, either along its depth (i.e., such that it can be laid flat), its length, (i.e., telescoping), or its width. In these embodiments, housing 110 includes appropriate hinges or joints to accomplish this folding or collapsing. In some embodiments, housing 110 may be inflatable or liquid-fillable. Housing 110 may be translucent, transparent, or opaque. Housing 110 may be painted, paintable, or otherwise colorable.

Housing 110 includes light aperture 112. Light aperture may be any suitable size or shape, but it is not opaque, and is instead either transparent or translucent to allow light to be emitted from the housing. In some embodiments, housing 110 includes more than one transmitting portion. These more than one light apertures may be on surfaces not in the same plane. In some embodiments, the light aperture includes a plurality of separate perforations or apertures, yet may still be considered a single light aperture (e.g., they are closely spaced and in the same plane). In some embodiments, the light aperture is simply a gap in housing 110. In some embodiments, light aperture 112 is a clear or translucent covering or window of housing 110. In some embodiments, light aperture 112 may include diffusing or hazy elements, pigments or other coloration, or a graphic or image. Light aperture 112 may include downconverting elements, such as a phosphor or quantum dots. These elements may be included on a film removably or repositionably placeable on, over, or behind the aperture, such that the character or appearance of the light aperture may be altered or adjusted depending on the application.

Housing 110 also includes insertion aperture 114. Insertion aperture 114 may be any suitable size or shape, and may be designed to accept the waveguiding core into the housing. Insertion aperture need not be specifically shaped to the waveguiding core, however, and may have any suitable shape to allow insertion of waveguiding cores into the housing. In some embodiments, an entire end of housing 110 may be considered an insertion aperture. Insertion aperture 114 may include or be a resealable or recloseable portion of housing 110, such as a flap with a hook-and-loop attachment mechanism or a zipper.

Waveguiding core 120 may be any suitable size and shape, but will be designed to fit inside housing 110. In some embodiments, waveguiding core 120 is the same or a similar shape as housing 110. In some embodiments, waveguiding core 120 is a different shape from housing 110. In some embodiments, waveguiding core 120 includes a reflective film. The reflective film may be rolled or formed into a tube, forming a hollow waveguiding core within. The waveguiding core has a length, l, and should be capable of transporting light along that length. The inner surfaces of waveguiding core 120 are the relevant reflective surfaces for the transportation of light. In some embodiments, the reflective film is a specular reflector, such as Enhanced Specular Reflector (“ESR”) (available from 3M Company, St. Paul, Minn.). In some embodiments, such as for ESR, the reflective film is a multilayer polymeric reflector. In some embodiments, the reflector is a semi-specular reflector or a diffuse reflector. Specularity refers to the degree of specular reflection for light incident on the reflector's surface. Specular reflectors provide a single reflection angle for a single incidence angle, diffuse reflectors provide a broad or even Lambertian reflection pattern for a single incidence angle, and semi-specular reflectors provide a reflection characteristic somewhere in between. For example, semi-specular reflection may be usefully characterized by its transport ratio, which may be given as the ratio of the difference of forward scattered light and back scattered light to the total light. Transport ratios of 0.7 or greater, as an example, may be useful to help transport light while providing enough scattering (albeit forward scattering) to hide defects and enhance uniformity. The proportion of waveguiding core 120 that includes reflective surfaces will depend on the desired application; however, in many cases, more than half of the surfaces of the waveguiding core will be reflective. Sometimes, waveguiding core has portions that are of different specularity, such as specular and diffuse portions, specular and semi-specular portions, semi-specular and diffuse portions, a gradient of specularity, or a combination of specular, semi-specular, and diffuse portions.

Waveguiding core 120 includes transmitting portion 122. Transmitting portion may be a separate film from the rest of waveguiding core 120, may have different optical characteristics, or may simple be an aperture without film. Transmitting portion 122 may be any suitable size or shape. Waveguiding core 120 may include more than one transmitting portion, wherein one, several, or each of the transmitting portions may have the characteristics described herein.

In some embodiments, the transmitting portion is a microstructured component. In some embodiments, transmitting portion 122 is a microstructured film. Any suitable microstructured film, such as a one- or two-side microreplicated film or turning film may be used. The microstructures may be linear prisms (i.e., prisms arranged parallel and elongated along a single common direction), linear lenses (i.e., structures arranged parallel that have a cross section of lenses or arcs and are elongated along a single common direction), pyramids, cones, or any other suitable shape or combination of shapes. In some two-sided structured films, the structures on the top and bottom sides may be the same or different. In these two-sided films, the structures on the top and bottom may be arranged so that an elongation direction of the structures of each surface are arranged orthogonally to one another. The bottom structures may be elongated parallel to the length of the waveguiding core or across it.

In some embodiments, transmitting portion 122 is a gradient of perforations or slits. The transmitting portion 122 may have a gradient in at least one of transmission, color, or angle of emission. Transmitting portion 122 may emit light uniformly from waveguiding core 120 when illuminated from one or either end. In some embodiments, transmitting potion 122 is or contains a light redirecting element. Transmitting portion 122 may overlap with at least one of the light apertures of the housing, when the waveguiding core is disposed within the housing.

Waveguiding core 120 may have a substrate or backing. In some embodiments, the waveguiding core may have a paperboard or cardboard backing. In some embodiments, the waveguiding core may have a polymeric backing, such as a PET. The substrate or backing should still be flexible or bendable without fracture, in some cases even beyond its yield point, allowing for the waveguiding core to be shaped. In some cases, the substrate or backing is a substrate that a polymer such as polycarbonate that is conformable or shapeable when heated, and hardens when cooled or at typical ambient temperatures. If the backing is opaque, the backing should not overlap or otherwise impede the transmission of light through the transmitting portion.

Waveguiding core 120 may have a reflective cap on one or both of its ends. The reflective cap may be a portion of reflective material (of the same piece as the rest of the reflector of the waveguiding core) folded up to form the reflective cap, or the reflective cap may be removable or reinsertable. In some embodiments, the reflective caps may fit into housing 110, and in some embodiments, the reflective caps may fit into waveguiding core 120. In some embodiments, the reflective caps may fit into both housing 110 and waveguiding core 120, and may secure the waveguiding core in place within the housing.

Waveguiding core 120 may be retained in housing 110 by friction, by a repositionable or stretch releasable adhesive, by compression, by mechanical retaining components within the housing, or by fitting into a sleeve within housing 110. Waveguiding core 120 may be easily or quickly removable from and reinsertable into the housing of the luminaire assembly.

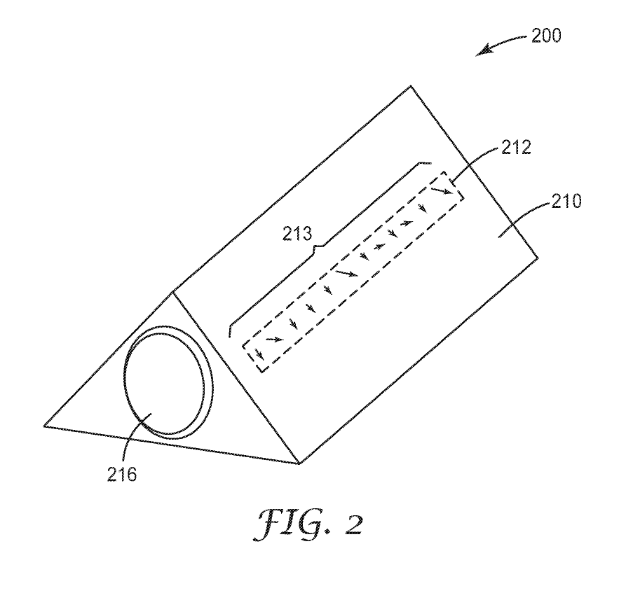

FIG. 2 is a top perspective view of a luminaire assembly. Luminaire assembly 200 includes housing 210 and light aperture 212, emitting light 213. Light engine 216 is disposed at least partially within housing 210. Although not pictured, luminaire assembly 200 includes a waveguiding core.

Light engine 216 may be any suitable shape or size, but may be configured to fit within the insertion aperture of the housing. In some embodiments, light engine 216 is designed to sit within a hollow waveguiding core. In some embodiments, either housing 210 or the waveguiding core may have a cavity or chamber to hide wires or other electronic components associated with the light engine. Light engine 216 may be able to be plugged into a power source, or it may be battery (replaceable or rechargeable) operated, or it may be powered or charged by a solar cell or through wireless power transfer. Light engine 216 may have an internal reflective surface.

Light engine 216 includes one or more light emitting diodes (LEDs) or any other suitable light source. The LEDs are disposed to inject light into the waveguiding core. The light sources may emit light of any suitable wavelength and may include phosphors, quantum dots, or other downconverters to provide an appropriate color. In some embodiments, the light engine includes collimating optics to provide a light distribution with a full width half maximum (FWHM) of 40 degrees, of 30 degrees, of 20 degrees or even less. In some embodiments, the light engine may include a diffuser to provide increased uniformity. In some embodiments, the light sources of the light engine may cover 30% or more, 50% or more, or 70% or more of the end area of the waveguiding core. In some embodiments, the light engine is a strip of LEDs or OLEDs that are disposed within the waveguiding core.

Light 213 ultimately emitted from light aperture 212 when light engine 216 provides light transported within the waveguiding core may have any suitable distribution. In some embodiments, the particular characteristics of the waveguiding core may enable different emission patterns from the same housing. In this way, waveguiding cores may be switched out or substituted depending on the application or the desired light output. For example, the luminaire assembly may have a broad emission pattern, a narrow emission pattern, a side emission pattern, a batwing emission pattern, or any other suitable emission pattern. In this way, a luminaire may function as many different styles of luminaires, requiring only minimal modification to replace the waveguiding core with the appropriate style.

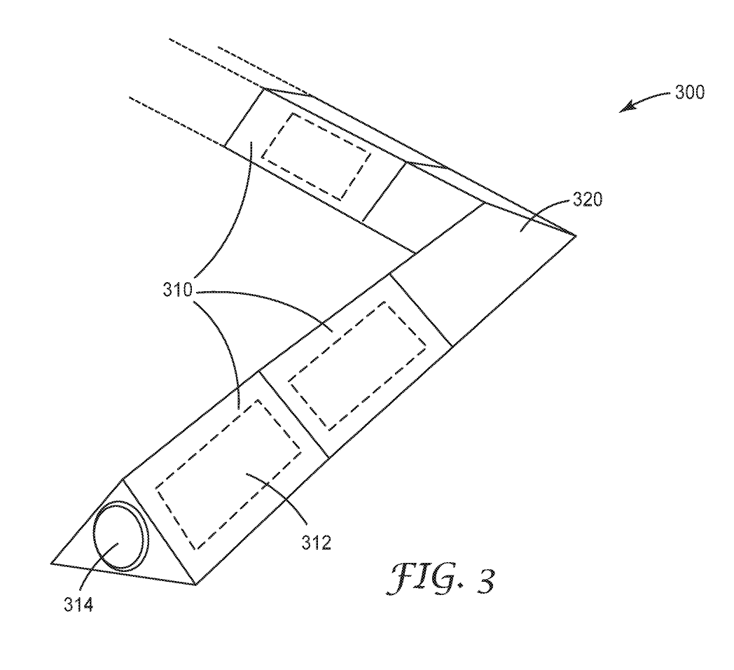

The luminaire assemblies described herein may be modular elements of an overall lighting design. For example, FIG. 3 is a partial top perspective view of several connected luminaire assemblies. Luminaire system 300 includes luminaire assemblies 310 with light apertures 312 connected together and joined at a right angle by L-shaped connector 320.

In some embodiments, the entire luminaire system 300 may be driven by a single light engine 314. In some embodiments, luminaire assemblies 310 may have a front and back removable reflective cap that can be used to join two luminaire assemblies together, such that light is guided through the waveguiding cores of the respective assemblies. The luminaire assemblies may be the same shape and size or they may be different. In some embodiments, the luminaire assemblies have the same shape and size but they are rotated differently or have different waveguiding cores to provide different emission patterns.

L-shaped connector 320 may have a waveguiding core that bends 90 degrees, a mirror disposed within a housing of the L-shaped connector, or any other suitable set of components to redirect light to continue along the path formed by the connected luminaire assemblies. Similar connector mechanisms but in different shapes may be suitable for other applications.

The modular system shown exemplarily in FIG. 3 may allow for real-time design choices or assembly of complicated and heavy luminaires through the easy attachment of easily transportable and individually repairable and replaceable components.

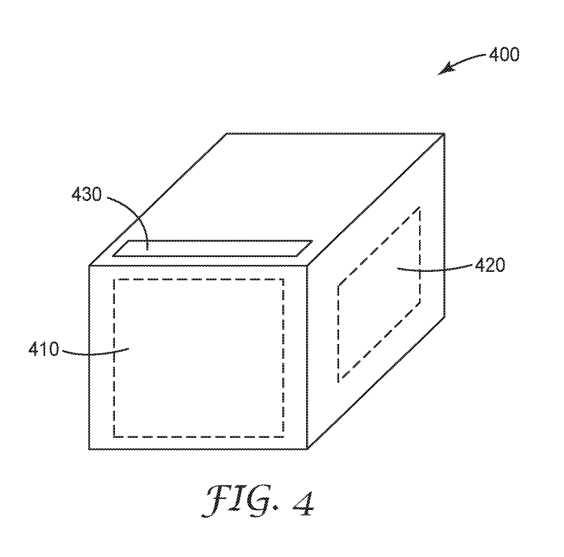

FIG. 4 is a top perspective view of a luminaire assembly. Luminaire assembly 400 includes insertion aperture 410, light aperture 420, and slot 430 and is similar to luminaire assemblies shown and described in FIGS. 1-3, but FIG. 4 is rectangular instead of triangular. Further, luminaire assembly 400 includes slot 430 which may be used to insert films, filters, or other optical elements that may adjust the characteristics of light ultimately outputted through light aperture 420, or, in the case of a modular system shown in FIG. 3, light for this luminaire assembly and others connected and further optically downstream. Slot 430 may be configured to receive a color filter, a diffuser, a switchable diffuser, a color wheel, a polarizer, a semi-transmissive screen used to dim the light output, or an opaque screen used to stop the propagation of light without disconnecting power or other luminaire assemblies.

While slot 430 represents one of the more simple ways to insert or modify color, for example, in luminaire assembly 400, other configurations are possible and contemplated. For example, particularly where the light sources of the light engine do not fill all of the area of insertion aperture 410, a mechanical wheel may be provided to remotely or electronically control which portion of the wheel light from the light sources of the light engine at least partially pass through. For example, this may allow for color changes even when the luminaire may be not easily accessible. In some embodiments, the mechanical wheel may include other types of filters, such as diffusers and filters of varying opacities, to manage the brightness and uniformity of light. The mechanical wheel may be connected to or may utilize one or more sensors to process information about the luminaires or about the ambient conditions, and adjust or rotate accordingly.

Some or all components of the luminaire assemblies and systems described herein may be compostable, degradable, or recyclable. For example, all of the components may be made from polymeric or wood pulp materials. In some embodiments, some or all of the components may be made from recycled materials. In some embodiments, some or all of the components may be made from flame retardant or non-flammable materials. In some embodiments, the housing may be impact absorbing or cushioned.

Descriptions for elements in figures should be understood to apply equally to corresponding elements in other figures, unless indicated otherwise. The present invention should not be considered limited to the particular examples and embodiments described above, as such embodiments are described in detail in order to facilitate explanation of various aspects of the invention. Rather, the present invention should be understood to cover all aspects of the invention, including various modifications, equivalent processes, and alternative devices falling within the scope of the invention as defined by the appended claims and their equivalents.

What is claimed is:

1. A luminaire assembly, comprising:
a dimensionally stable housing;
a hollow waveguiding core having a length and capable of transporting light along the length removably nested within the housing.

2. The luminaire assembly of claim 1, wherein the hollow waveguiding core includes a multilayer optical film.

3. The luminaire assembly of claim 1, wherein the hollow waveguiding core includes a reflector.

4. The luminaire assembly of claim 1, wherein the hollow waveguiding core includes a reflecting portion and a transmitting portion.

5. The luminaire assembly of claim 4, wherein the reflecting portion is a specular reflector.

6. The luminaire assembly of claim 4, wherein the reflecting portion is a semi-specular reflector.

7. The luminaire assembly of claim 4, wherein the reflecting portion is a diffuse reflector.

8. The luminaire assembly of claim 4, wherein the transmitting portion includes perforations.

9. The luminaire assembly of claim 8, wherein the transmitting portion includes a gradient of perforations.

10. The luminaire assembly of claim 4, wherein the transmitting portion includes a microstructured film.

11. The luminaire assembly of claim 4, wherein the transmitting portion includes a diffuser.

12. The luminaire assembly of claim 1, wherein the dimensionally stable housing defines at least one aperture.

13. The luminaire assembly of claim 4, wherein the dimensionally stable housing defines at least one aperture, and wherein at least a portion of the transmitting portion overlaps with the at least one aperture.

14. The luminaire assembly of claim 1, wherein the hollow waveguiding core is retained within the dimensionally stable housing by friction.

15. The luminaire assembly of claim 1, wherein the hollow waveguiding core is retained within the dimensionally stable housing by compression.

16. The luminaire assembly of claim 1, wherein the dimensionally stable housing includes mechanical retaining components, and wherein the hollow waveguiding core is retained within the dimensionally stable housing by use of the mechanical retaining components.

17. The luminaire assembly of claim 1, wherein the dimensionally stable housing and the hollow waveguiding core are not the same shape.

18. The luminaire assembly of claim 1, wherein the dimensionally stable housing defines a plurality of apertures, and the apertures are not on surfaces in a same plane.

19. The luminaire assembly of claim 1, further comprising a light engine disposed to inject light into the hollow waveguiding core.

20. The luminaire assembly of claim 19, wherein the dimensionally stable housing includes a slot, and wherein the slot includes an optical filter, such that light injected from the light engine into the hollow waveguiding core at least partially passes through the optical filter.

21. A luminaire system, comprising:
Two or more luminaire assemblies of claim 1, disposed such that light transported within the hollow waveguiding core of at least one of the luminaire assemblies enters the hollow waveguiding core of another of the luminaire assemblies.

22. The luminaire system of claim 21, further comprising an L-shaped connector between at least two of the two or more luminaire assemblies.
